(19) United States
(12) Patent Application Publication
(10) Pub. No.: US 2008/0087362 A1
(43) Pub. Date: Apr. 17, 2008

(54) Motor Vehicle Pneumatic Tyre

(75) Inventor: Markus Metz, Neustadt (DE)

Correspondence Address: GREENBLUM & BERNSTEIN, P.L.C., 1950 ROLAND CLARKE PLACE, RESTON, VA, 20191, US

(73) Assignee: CONTINENTAL AKTIENGESELLSCHAFT, Hannover (DE)

(21) Appl. No.: 11/569,157

(22) PCT Filed: Jul. 8, 2005
(86) PCT No.: PCT/EP05/07384

§ 371 Date: Nov. 15, 2006

(30) Foreign Application Priority Data
Aug. 6, 2004 (DE) 10 2004 038 141.0

(51) Int. Cl. B60C 13/02

(52) U.S. Cl. 152/523

(57) ABSTRACT

Vehicle pneumatic tire includes a carcass having sidewalls and a tread rubber. A sidewall area is covered on an outside by a sidewall rubber strip. A moiré pattern is arranged on the sidewall rubber strip and is formed by a superimposition of at least two linear non-identical families of curves. A first family of curves of the at least two linear non-identical families of curves is formed by undulatory curves having regular wave form. A second family of curves of the at least two linear non-identical families of curves is formed by undulatory curves having irregular wave form. This abstract is not intended to define the invention disclosed in the specification, nor intended to limit the scope of the invention in any way.

### CROSS-REFERENCE TO RELATED APPLICATIONS

The present application is a U.S. National Stage of International Patent Application No. PCT/EP2005/007384 filed Jul. 8, 2005 which published as WO 2006/015674 on Feb. 16, 2006, and claims priority of German Patent Application No. 10 2004 038 141.0 filed Aug. 6, 2004.

### BACKGROUND OF THE INVENTION

1. Field of the Invention

The invention relates to a vehicle pneumatic tire with a carcass, in particular, utilizing a radial construction, sidewalls and a tread rubber. The carcass is outwardly covered with a sidewall rubber strip in the sidewall area.

2. Discussion of Background Information

Constructing vehicle pneumatic tires from several different layers from the radial inside to the radial outside is known, e.g., with tires of radial construction having an inner layer, carcass, belt and tread rubber, and in the side region having an inner layer, carcass and side area. Carcasses of vehicle pneumatic tires are usually constructed from one or more plies of reinforcements respectively embedded in rubber parallel to one another. The individual carcass plies are thereby made of continuous rubber bands having reinforcements arranged parallel in the direction of the rubber band. Depending on the desired bias position of the reinforcements to the tire equator plane, the rubber bands provided with embedded reinforcements are usually cut into individual pieces on the bias in the subsequent tire construction or transversely for radial carcass construction. The uncut sides of the pieces thus obtained, which previously already represented the sides of the rubber band, are then usually connected to one another to form a continuous carcass ply. As soon as the carcass length desired for the circumference of the tire has been reached, the carcass ply formed from the individual carcass pieces cut on the bias or transversely is placed on the building drum on the already prepared inner layer, on a carcass layer already placed there, or, if necessary, on additional intermediate layers. The carcass ply is thereby laid around the entire circumference, and typically has its end areas connected to one another with individual reinforcements being overlapped. Subsequently, depending on the desired design, additional carcass layers, intermediate layers, belt plies and tread are applied. During the production process, it is customary to produce the desired green tire form by expanding the building drum provided with the carcass plies in the radial direction during shaping.

After the vulcanization and finishing of the tire, as soon as it has been inflated to its operating state, thickened areas, which have been produced by the overlapping of several reinforcements in the carcass structure, become noticeable in a negative way, in particular, in the outer carcass ply. The reinforcements are namely greatly stretched by the shaping and are shrunk during the subsequent vulcanization, so that particularly solid carcass regions result here. As soon as the tire in its fitted state is loaded with internal pressure, this solidified area, in particular, exhibits a substantially weaker expansion behavior than the surrounding carcass regions. The differing strength and elasticity behavior of the carcass in these regions leads to visibly detectable constrictions. This is particularly noticeable when polyester is used for the carcass reinforcements.

Several suggestions have been made for reducing or optically masking the constrictions arising from the overlapping.

For example, EP 0 239 160 B1 proposes providing additional splicing strips in the overlapping region. EP 0 407 134 B1 proposes applying additional rubber strips in the overlapping region at least in the region of the bead core. The strips serve as elastic cushions in the core region so that where there is excess internal pressure, the reinforcements in the overlapping region migrate radially outwards from the core under elastic compression of the cushion, and the constriction ought thus to be largely masked. The quality of the masking of the constriction behavior thereby depends on the thickness of the rubber strip used. The additional strip leads to the development of additional uniformity problems, as compared to conventional tires, depending on the thickness of the strip. Depending on the thickness of the rubber strip, additional air inclusions can form on both sides of the strip between the layer covering the rubber strip and the carcass layer. At great expense, for example, by additional rolling of the layer covering the rubber strip, a distribution of the air inclusions is conceivable, at least when the rubber strips between the covering layer and the carcass are thin. However, the elongated covering of the carcass ply by the covering layer prevents the removal of the air inclusions. Insofar as they have been distributed from the direct region of the rubber strip, they are nevertheless essentially retained as air inclusions between the carcass and the covering layer, and lead to additional problems regarding the durability of the tire. Due to the problems arising from this, satisfactory covering of the constrictions with the aid of an additional rubber strip of this type can be realized, if at all, only with considerable additional expense for the removal of the air inclusions and for the elimination of the additional uniformity problems.

It is known from DE 199 06 658 C2 to arrange a moirépattern on the sidewall rubber strip, which pattern is formed from the superimposition of at least two linear families of curves. The formation of a moiré pattern from linear elevations, by the distribution of the intensity of the reflected light as a result of the interferences of the line patterns, causes a superimposition on the tire sidewall such that these comparatively slight changes in reflection caused by possible constriction effects are hardly perceptible by the naked eye. This can be implemented within the scope of tire sidewall decorative design without the laborious measures known from EP 0407134B1. In DE 19906658C2, concrete moiré patterns are proposed which are composed of the superimposition of straight radial, curved radial, circular or parallel straight lines.

### SUMMARY OF THE INVENTION

The invention improves the effect of covering slight irregularities in the outer contour of the vehicle tire sidewall.

According to one embodiment of the invention, there is provided a vehicle pneumatic tire with a carcass, in particular, with a radial construction, sidewalls and a tread rubber, whereby the carcass is outwardly covered in the sidewall region with a sidewall rubber strip and whereby a moiré pattern is arranged on the sidewall rubber strip. The pattern is formed by the superimposition of at least two linear non-identical families of curves in which the first family of curves is formed from undulatory curves with regular wave form and the second family of curves is formed from undulatory curves with irregular wave form. Through the superimposition of a first family of curves of undulatory curves with regular wave form and a second family of curves of undulatory curves with irregular wave form, a very irregular moiré pattern is formed with interference figures with different appearances. This makes it particularly difficult for irregularities, e.g., caused by constriction effects of the sidewall, in the tire sidewall contour to be detected by the human eye.

An embodiment is particularly advantageous when the first family of curves is made up of undulatory curves that extend in the circumferential direction of the vehicle pneumatic tire. This renders possible in a simple manner a transition occurring in the circumferential direction of the families of curves of individual circumferential sections and a repeat.

An embodiment is particularly advantageous when the second family of curves is made up of undulatory curves with irregular wave form which extend in the circumferential direction of the vehicle pneumatic tire. This renders possible in a simple manner a transition occurring in the circumferential direction of the families of curves of individual circumferential sections and a repeat.

Due to the simple targeted irregularity, an embodiment according can be particularly advantageous when the second family of curves is made up of undulatory curves with irregular frequency of their wave form. Irregularities can be hidden particularly well in, behind or under other irregularities.

Due to the simple targeted irregularity, an embodiment according can be particularly advantageous when the second family of curves is made up of undulatory curves with varied amplitude along their wave propagation, whereby the second family of curves is made up of undulatory curves with irregular frequency of their wave form. Irregularities can be hidden particularly well in, behind or under other irregularities.

The invention also provides for a vehicle pneumatic tire comprising a carcass having sidewalls and a tread rubber, a sidewall area covered on an outside by a sidewall rubber strip, and a moiré pattern arranged on the sidewall rubber strip and being formed by a superimposition of at least two linear non-identical families of curves. A first family of curves of the at least two linear non-identical families of curves is formed by undulatory curves having regular wave form and a second family of curves of the at least two linear non-identical families of curves is formed by undulatory curves having irregular wave form.

The tire may comprise a radial construction. The tire may further comprise marking arranged on the sidewall area providing information about the tire. The first family of curves may extend in a circumferential direction. The second family of curves may extend in a circumferential direction. The second family of curves may have an irregular wave form frequency. The second family of curves may have a changing wave amplitude. In a transition between first and second surface areas, a curve of the first family of curves of a first surface area may merge smoothly into a curve of a first family of curves of the second surface area. In a transition between first and second surface areas, a curve of the second family of curves of the first surface area may merge smoothly into a curve of the second family of curves of the second surface area. In a transition between first and second surface areas, curves of the first family of curves of the first surface area may merge smoothly into curves of the first family of curves of the first surface area. In a transition between first and second surface areas, curves of the second family of curves of the first surface area may merge smoothly into curves of the second family of curves of the first surface area. In a transition between first and second surface areas, one curve of the first family of curves of the at least one first surface area may merge smoothly into curves of the first family of curves of the second surface area. In a transition between first and second surface areas, one curve of the second family of curves of the at least one first surface area may merge smoothly into curves of the second family of curves of the second surface area. In a transition between first and second surface areas, a curve of the first family of curves of the first surface area may have identical pitch to a curve of the first family of curves of the second surface area. In a transition between first and second surface areas, a curve of the second family of curves of the first surface area may have identical pitch to a curve of the second family of curves of the second surface area.

The tire may comprise three first surface areas each having markings. The tire may comprise a second surface area arranged between two first surface areas. An irregular brightness distribution produced the moiré pattern may be superimposed on a variation in a brightness distribution produced by a constriction of one of the sidewalls. The variation in the brightness distribution produced by the constriction may not clearly be identifiable as such, whereby only a non-uniform brightness distribution is recognizable

The invention also provides for a vehicle pneumatic tire comprising a sidewall area comprising a sidewall rubber strip and a moiré pattern arranged on the sidewall area and being formed by a superimposition of first and second linear non-identical families of curves. The first family of curves are formed by undulating curves having regular wave form and the second family of curves are formed by undulating curves having irregular wave form.

The invention also provides for a vehicle pneumatic tire comprising a marking arranged in at least one first surface area of a sidewall and a moiré pattern arranged on at least one second surface area and being formed by a superimposition of at least two non-identical families of curves. One family of curves is formed by undulating curves having regular wave form and another family of curves is formed by undulating curves having irregular wave form. An irregular brightness distribution produced the moiré pattern is superimposed on a variation in a brightness distribution produced by a constriction of the sidewall.

### BRIEF DESCRIPTION OF THE DRAWINGS

The invention is described below on the basis of the exemplary embodiments shown in more detail in FIGS. 1 through 8, wherein:

FIG. 1 shows a diagrammatic structure of a tire in cross-sectional view;

FIG. 2 shows a diagrammatic tire structure in perspective view;

FIG. 3 shows a diagrammatic view of the covering of the plies in the building-up process;

FIG. 4 shows a diagrammatic view of a sidewall with different circumferential sections;

FIGS. 5a, 5b, 5c and 5d show diagrammatic views of a sidewall to clarify the moiré patterns;

FIGS. 6a, 6b and 6c show diagrammatic views of a second surface area of a sidewall without informative numbers, but with moiré pattern;

FIGS. 7a, 7b and 7c show diagrammatic views of a first surface region of a sidewall with informative numbers, but with moiré-free pattern; and

FIG. 8 Diagrammatic representation of the transition between first and second surface region.

### DETAILED DESCRIPTION OF THE INVENTION

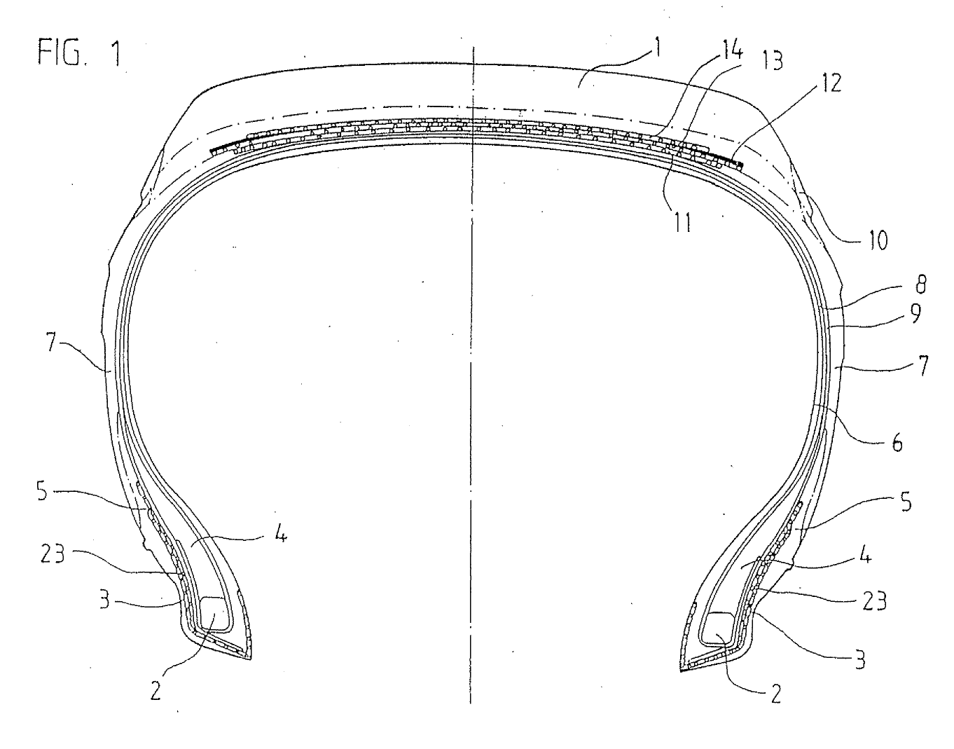

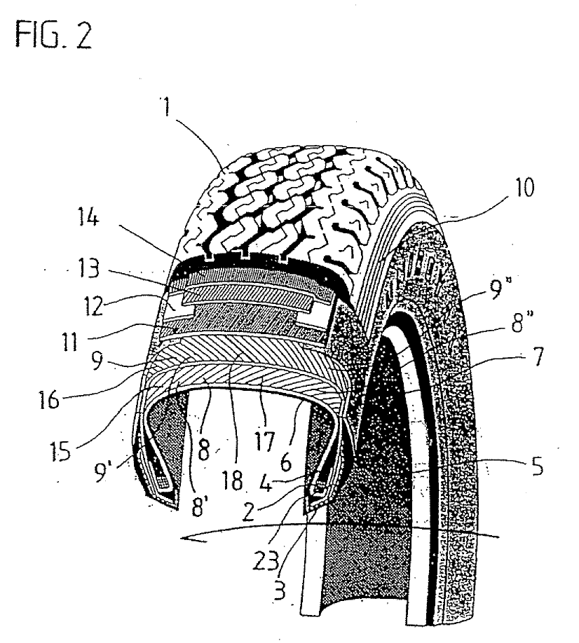

FIGS. 1 and 2 diagrammatically illustrate the structure of a vehicle pneumatic tire, by way of example, in which, around a core 2 with a core profile 4, a first carcass ply 8 extends beyond a dense inner layer 6 over the right shoulder region and the zenith plane to the left shoulder region and the left core 2 with core profile 4, around which it is laid in a conventional manner. A second carcass ply 9, which likewise extends from the side of the tire shown on the right in FIG. 1 to the side shown on the left, is laid in a conventional manner over the first carcass ply 8. Both carcass plies are manufactured in a conventional manner from a carcass ply/rubber mixture of known type, and with rubber bands built up with textile yarns 8 or 9 of known construction embedded therein and lying respectively parallel to one another.

These rubber bands are cut on the bias on a cutting table in a known manner and are then joined to one another at their parallel uncut sides.

For each carcass ply, two carcass pieces 8′, 8″ or 9′, 9″ of this type respectively are shown in FIG. 2. The carcass ply piece 8′ is laid on the carcass ply piece 8″ at the joint 17 such that individual yarns overlap each other. The carcass ply piece 9′ is likewise laid on the carcass piece 9″ at the joint 18 with overlapping.

In the exemplary embodiment of FIG. 2, a flange profile 5 is laid in the core region over a bead strip 23 and the bead reinforcement 3 in a conventional manner, and starting from this flange profile, a side strip 7 is laid extending into the shoulder region. Several steel belt plies 11, 13, and a nylon bandage 14 with a belt edge protection 12 of a known type, are positioned between them and extend over the circumference of the tire lying outside the carcass plies. Additionally, shoulder strips 10 are laid in the shoulder region. In a known manner, a tread rubber 1 completes the tire structure.

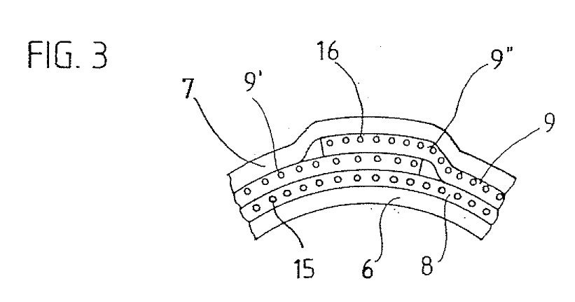

In FIG. 3, the overlapping area 18 is shown in sectional view perpendicular to the carcass yarns. The inner carcass layer 8 is thereby formed in a known manner with carcass yarns 15. The carcass yarns 15 lie in the central plane of the carcass ply 8. In the outer carcass ply 9, carcass yarns 16 are embedded in the central plane of the carcass layer 9.

During shaping and vulcanization, the carcass yarns 16 of polyester are strongly stretched and subsequently shrunk again. The polyester yarns of the overlapping ends 9″ and 9′ contract tightly thereby in the overlapping region of carcass 9. During the expansion of the tire and, therefore, of the carcass ply 9, into the operating state with excess pressure in the tire, the carcass yarns 16 stretch less in this overlapping region thus solidified than the carcass yarns outside the overlapping region of the carcass ends 9′, 9″ so that a constriction of the sidewall occurs in the overlapping region.

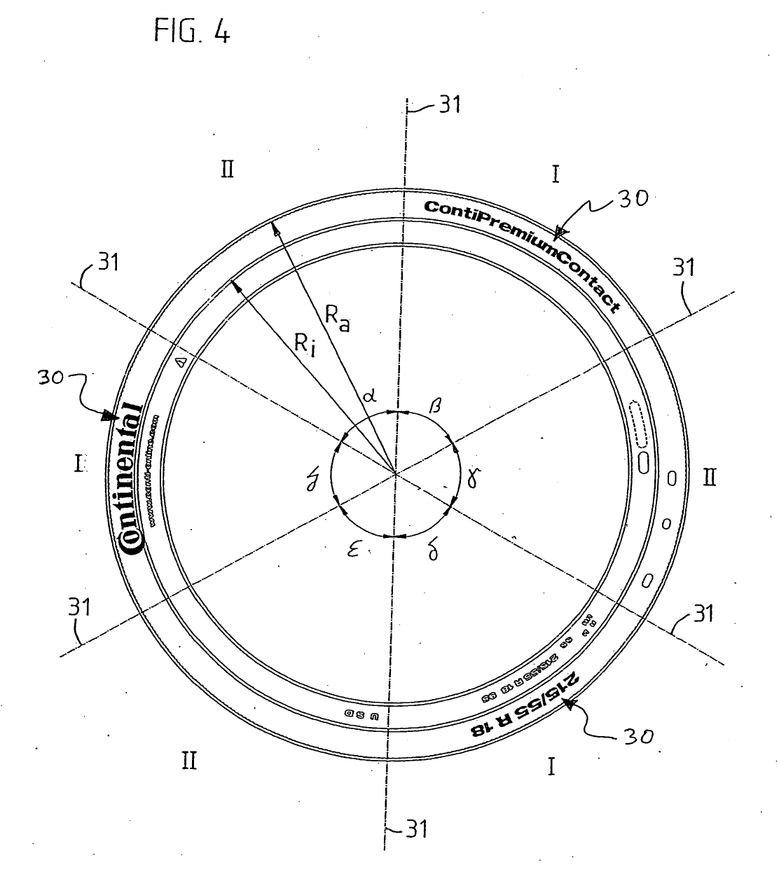

As shown in FIG. 4, the tire sidewall is embodied with a sidewall decoration 30 on the outside of the sidewall strip 7. The sidewall decoration 30 thereby extends in the radial direction R of the vehicle pneumatic tire between an internal radius Rᵢ and an external radius Rₐ, and in the circumferential direction U of the vehicle pneumatic tire over the entire vehicle pneumatic tire. In the exemplary embodiment shown, the sidewall decoration 30 is formed from three first circumferential sections I that extend over the circumferential angular sections β, δ and ζ, and from three second circumferential sections II that extend over the circumferential angular sections α, γ and ε. In the surfaces of the first circumferential sections I of the tire decoration, symbols are respectively embodied in a known manner (not shown in further detail) to provide information on the vehicle pneumatic tire, e.g., difference from other vehicle pneumatic tires or on technical details of the vehicle pneumatic tire, e.g., by giving the tire dimension. In the surfaces of the second circumferential sections II of the tire decoration, no symbols of this type are embodied in a known manner (not shown in further detail) to provide information on the vehicle pneumatic tire, e.g., difference from other vehicle pneumatic tires or on technical details of the vehicle pneumatic tire, e.g., by giving the tire dimension. The circumferential sections I and II are respectively embodied directly one behind the other in the circumferential direction in alternating sequence. On both ends of a circumferential section I embodied in the circumferential direction U, a circumferential section II begins respectively in a circumferential position represented respectively by reference number 31. On both ends of a circumferential section II embodied in the circumferential direction U, a circumferential section I begins respectively in a circumferential position represented respectively by reference number 31. The sum of the angles α, β, γ, δ, ε and ζ forms 360° in the exemplary embodiment shown. In the exemplary embodiment shown, the angles α, γ and ε are chosen to be the same size: α=γ=ε. Likewise, in the exemplary embodiment shown, the angles β, δ and ζ are chosen to be the same size: β=δ=ζ. For example, as in the exemplary embodiment shown, the angles α, β, γ, ε and ζ are chosen to be the same size: α=β=γ=ε=ζ=60°.

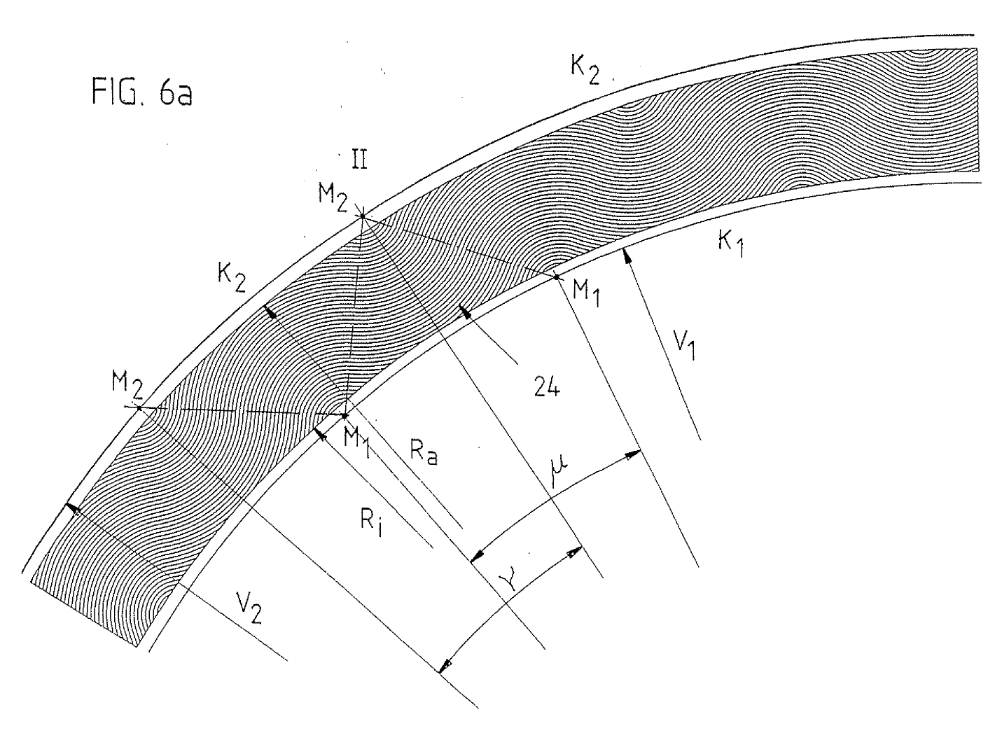

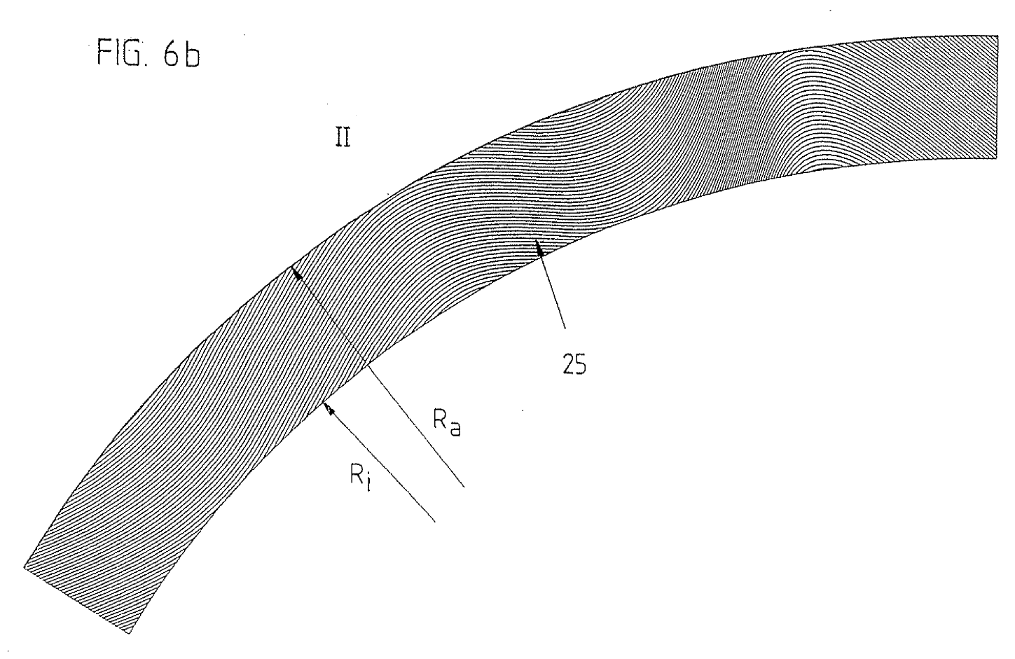

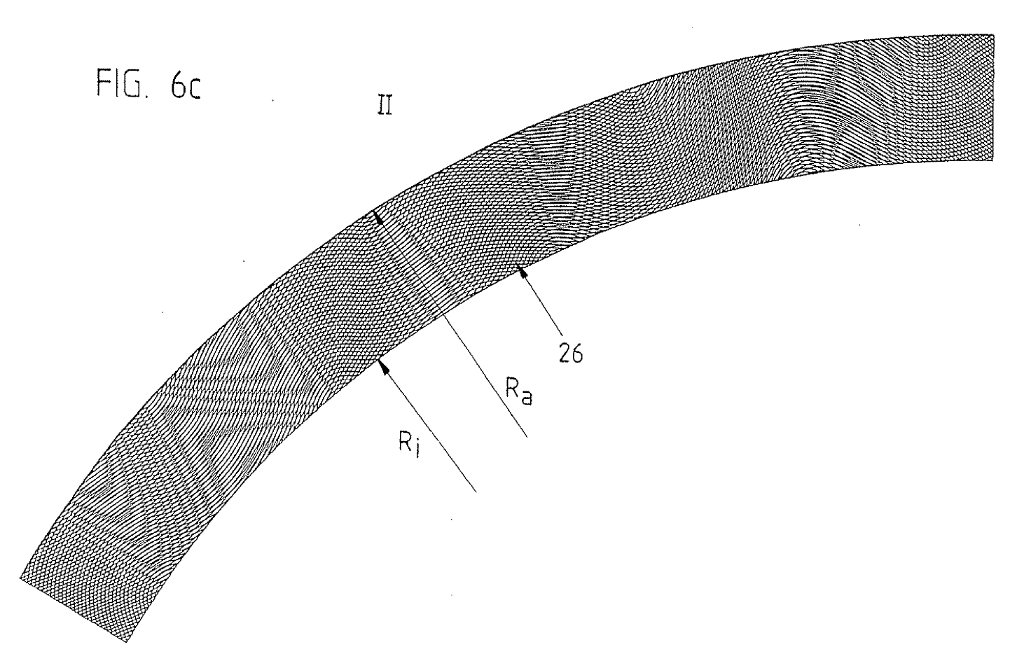

The sidewall decoration 30 is a moiré pattern respectively formed by two overlapping linear patterns in the radial extension region between the internal radius Rᵢ and the external radius Rₐ in the second circumferential regions II—as shown in FIG. 6c. A moiré pattern is an interference figure of at least two overlapping linear patterns in which a brightness distribution arises from interference in the form of a standing wave.

The moiré pattern in FIG. 6c is produced by overlapping the two families of curves shown in FIG. 6a and FIG. 6b. The family of curves shown in FIG. 6a is formed by a plurality of undulatory curves with regular wave form spaced apart from one another in the radial direction of the vehicle pneumatic tire. The curves extend in the circumferential direction of the vehicle pneumatic tire.

In the embodiment shown in FIG. 6a, the family of curves is produced as follows: On an inner circular path K1 embodied concentrically to the vehicle pneumatic tire, inner centers M₁ are arranged respectively at the same angle μ to one another and on an outer circular path K2 embodied concentrically to the vehicle pneumatic tire inner are arranged respectively at the same angle v to one another. The centers M₂ are thereby arranged respectively on the midperpendicular to two adjacent centers M₁. An identical number of circle segments with the same radial distance from the associated center M₁ or M₂ is respectively formed around the centers M₁ and the centers M₂ towards the other circular path K2 or K1 so that respectively one circle segment formed around a center M₁ merges aligned into respectively one corresponding circle segment of the adjacent center M₂. The transition occurs on a path connecting the centers M₁ and M₂.

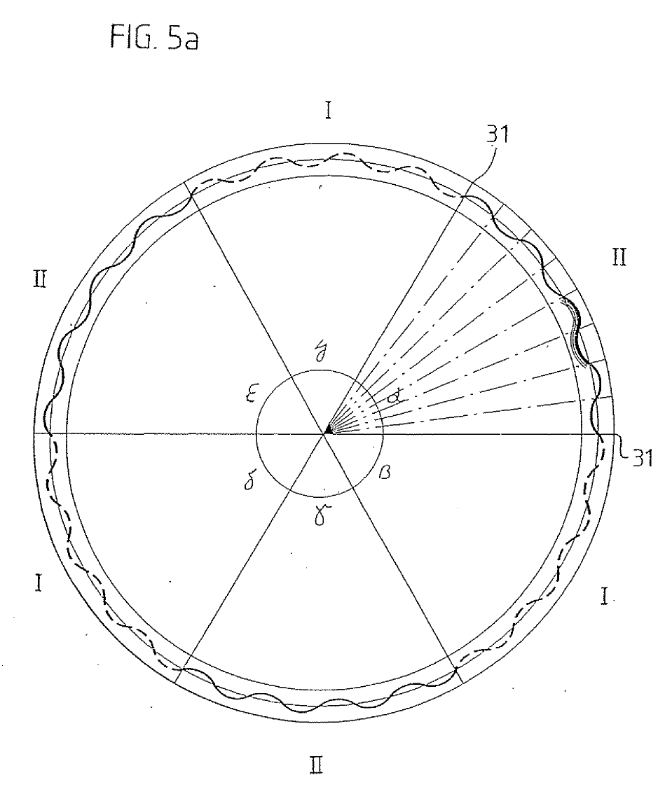

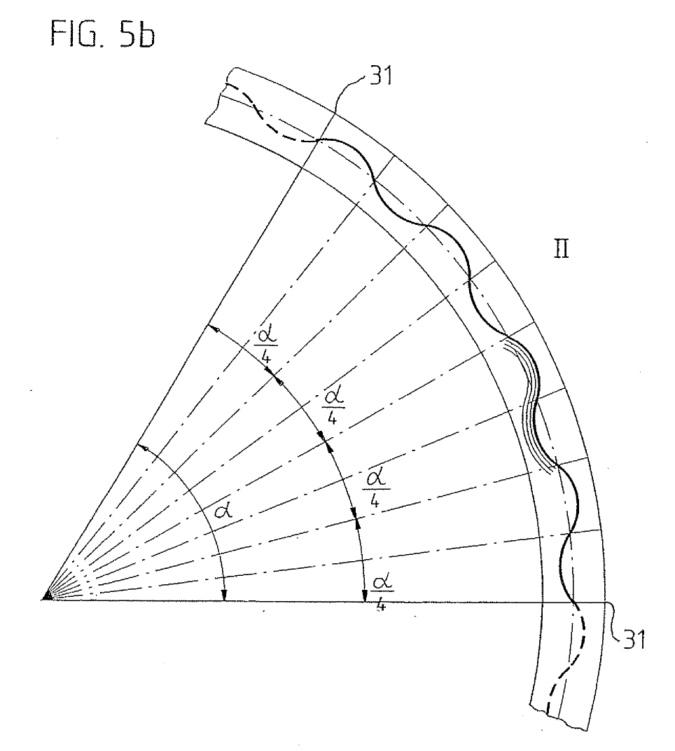

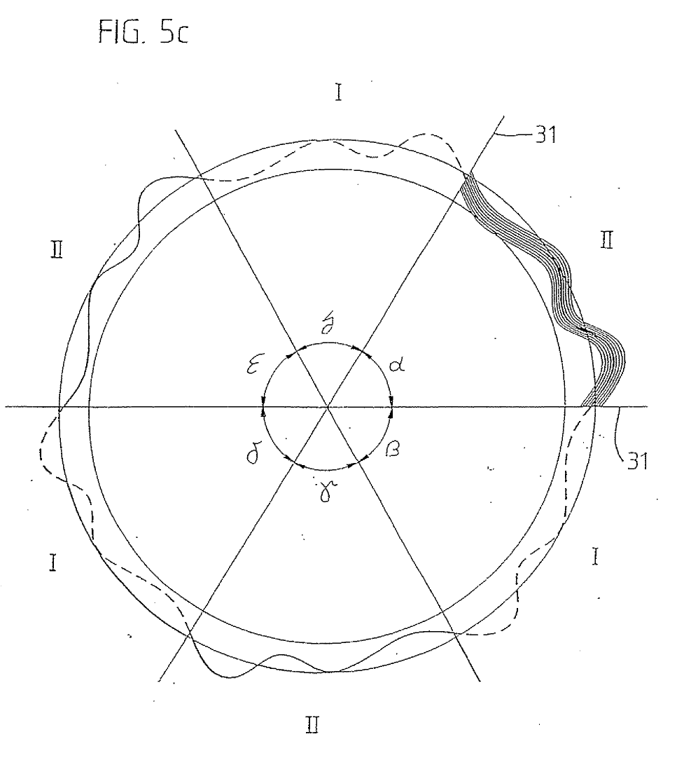

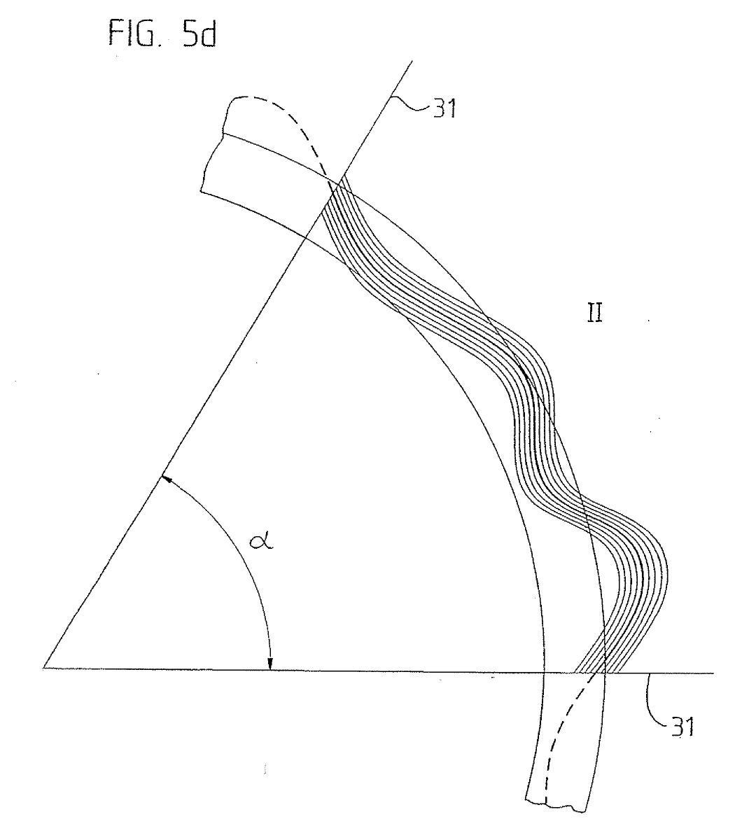

The other family of curves, shown in FIG. 6b, is embodied from a plurality of undulatory curves with irregular wave form spaced apart from one another in each circumferential position of the vehicle pneumatic tire respectively in this circumferential position at the same radial distance r₁. The curves extend in the circumferential direction of the vehicle pneumatic tire. The zero passages of the curves occur in the same circumferential position. Circumference-related phases of the family of curves and the amplitudes change along their extension in irregular sequence. This is clearly shown in FIGS. 5c and 5d.

FIG. 6c shows the two families of curves of FIG. 6a and FIG. 6b superimposed. An interference figure of the two families of curves is formed, whereby particularly bright regions form in the region of line intersections. The entire interference figure thereby shows a brightness distribution as with an undulatory spread with a standing wave.

In the sidewall decoration, the dark lines of the two families of curves are fine impressed or raised grooves in the surface of the rubber. The grooves have a round or angular cross-sectional contour.

The irregular brightness distribution that is produced on the sidewall by the moiré effect is superimposed on the variation in the brightness distribution produced by the constriction of the tire sidewall. The variation in the brightness distribution produced by the constriction of the tire sidewall is no longer clearly identifiable as such. Only a non-uniform brightness distribution, apparently produced by the tire decoration, is recognizable.

In another embodiment, alternatively to the family of curves shown and described in FIG. 6a, a family of curves is embodied that is embodied, e.g., from a plurality of undulatory curves with regular wave form spaced apart from one another in the radial direction of the vehicle pneumatic tire at respectively the same distance. The curves extend in the circumferential direction of the vehicle pneumatic tire. The lines of the zero passages of the undulatory curves are respectively concentric circular paths, e.g., concentric to the vehicle pneumatic tire. The zero passages of the curves occur in the same circumferential position. Circumference-related phases and the amplitudes of the curves are respectively constant along the entire extension. This is clearly shown in FIGS. 5a and 5b in which, for the purpose of simplification, only one curve of the curve family with its zero line is drawn over the whole extension.

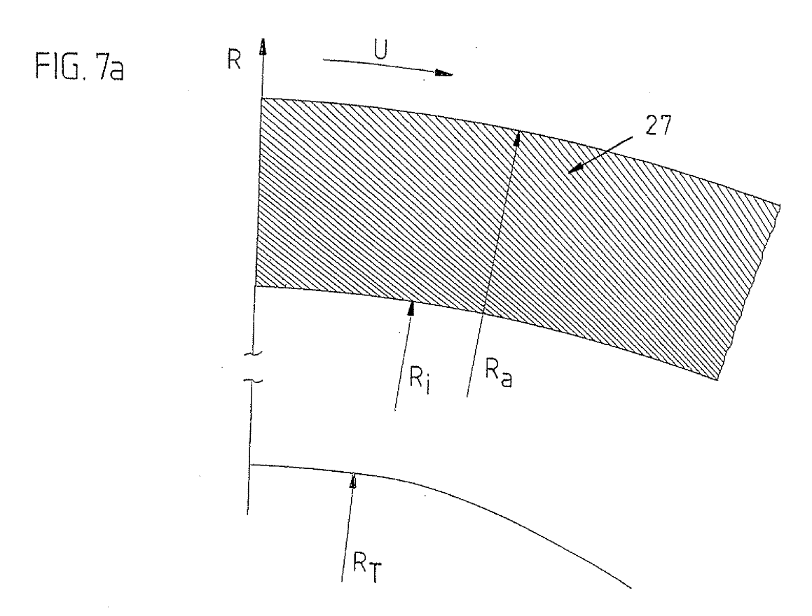

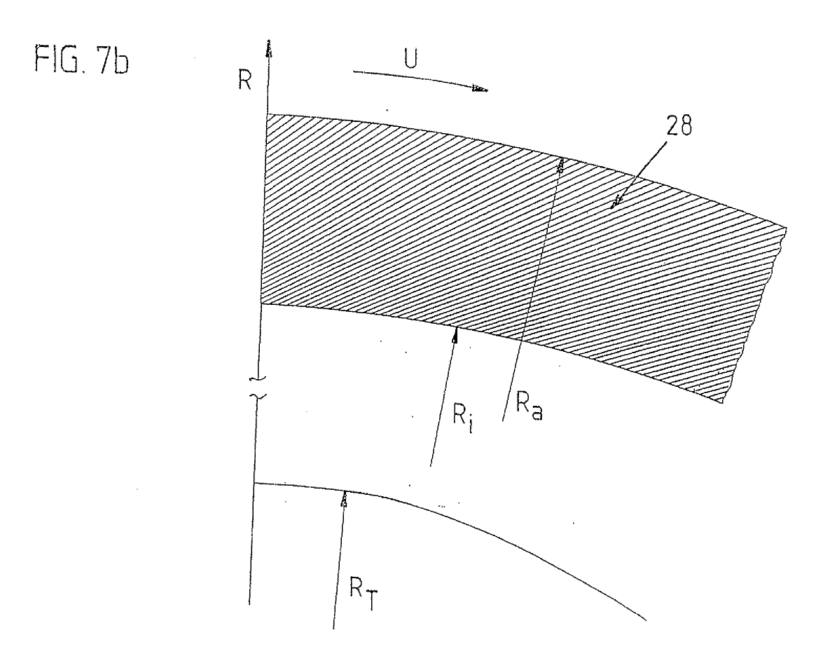

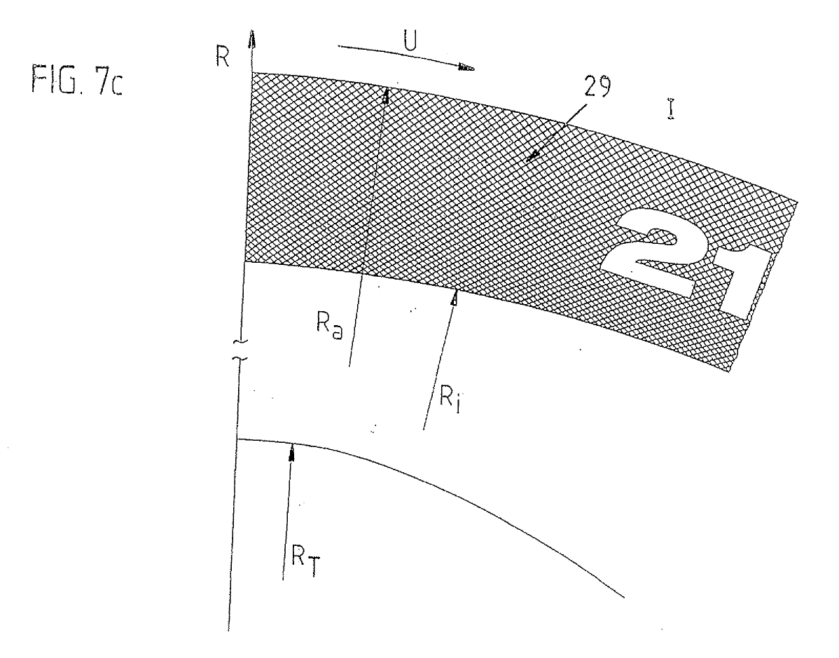

The sidewall decoration 30 is a moiré-free pattern formed by two overlapping linear patterns in the radial extension region between the internal radius Rᵢ and the external radius Rₐ in the first circumferential region I—as shown in FIG. 7c.

The moiré-free pattern in FIG. 7c is produced by overlapping the two families of curves shown in FIG. 7a and FIG. 7b. The family of curves shown in FIG. 7a is formed by a plurality of tangents abutting against a circle with a radius R_{T}, whereby the spacing of adjacent tangent points on the circle is respectively the same. The other family of curves, shown in FIG. 7b, is likewise formed by a plurality of tangents abutting against a circle with a radius R_{T}, whereby the spacing of adjacent tangent points on the circle is respectively the same. The pitch direction of the tangents of the first family of curves is opposite to the pitch direction of the tangents of the second family of curves. These two circles, for forming the families of curves shown diagrammatically in FIGS. 7a and 7b and for forming the tangents, are equal in size and concentric. In one exemplary embodiment, these two circles are concentric to the vehicle tire. As shown in FIG. 7c, in one exemplary embodiment, the pattern is interrupted by the informative numbers formed in the circumferential region I in the surface of the tire sidewall.

In sidewall decoration, the dark lines of the two families of curves are thereby fine embossed or raised grooves in the surface of the rubber. The grooves have a round or angular cross-sectional contour.

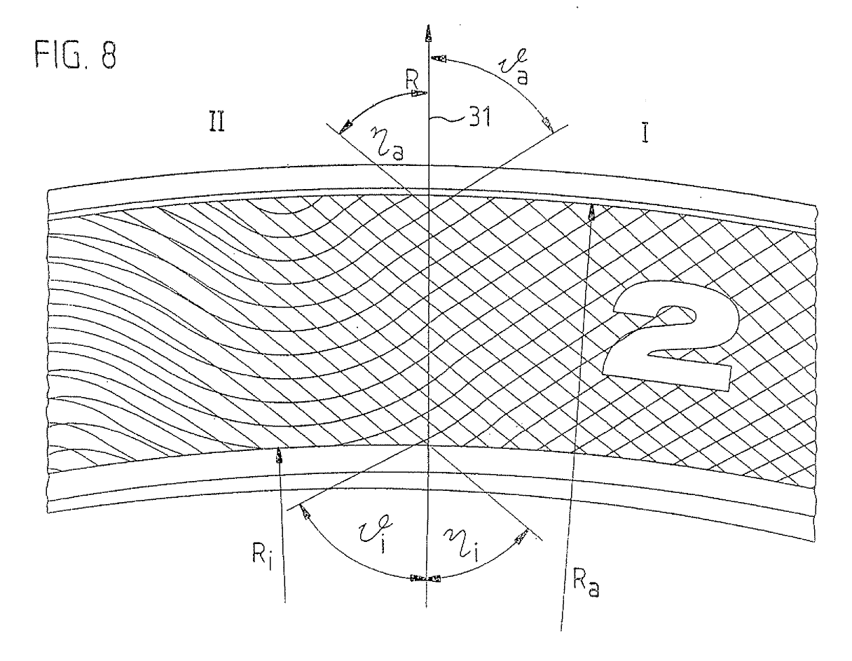

FIG. 8 shows in more detail the transition 31 of the families of curves of the circumferential regions I to the families of curves of the circumferential regions II at the segment border between these regions. For the sake of clarity, only every sixth curve of a family of curves is thereby shown. As can be clearly seen, respectively, one curve of a first family of curves of the circumferential region II merges smoothly into a curve of a first family of curves of the circumferential region I. This curve is embodied with the same pitch in the transition 31 and corresponds thereto. As can be clearly seen, respectively, one curve of a second family of curves of the circumferential region II merges smoothly into a curve of a second family of curves of the circumferential region I. This curve is embodied with the same pitch in the transition 31 and corresponds thereto. Thus, for example, the curve of the first family of curves in the circumferential region II, which curve lies innermost in the transition 31 in the radial direction of the vehicle pneumatic tire and has the pitch angle ηᵢ embodied in the transition 31, smoothly merges into a curve of the first family of curves of the circumferential region I. This curve lies innermost in the radial direction of the vehicle pneumatic tire and is embodied with the same pitch angle ηᵢ in the transition 31 and assigned thereto in a corresponding manner in the transition 31. Likewise, the curve of the second family of curves of the circumferential region II, which curve lies innermost in the transition 31 in the radial direction of the vehicle pneumatic tire and has the angle of pitch θᵢ embodied in the transition 31, merges smoothly into a curve of the second family of curves of the circumferential region I. This curve lies innermost in the transition 31 in the radial direction of the vehicle pneumatic tire and is embodied with the same angle of pitch θᵢ in the transition 31 and assigned thereto in a corresponding manner. Likewise, for example, the curve of the first family of curves of the circumferential region II, which curve lies outermost in the transition 31 in the radial direction of the vehicle pneumatic tire and has the pitch angle ηₐ embodied in the transition 31, merges smoothly into a curve of the first family of curves of the circumferential region I. This curve lies outermost in the transition 31 in the radial direction of the vehicle pneumatic tire and is embodied with the same angle of pitch ηₐ in the transition 31 and assigned thereto in a corresponding manner. Likewise, the curve of the second family of curves of the circumferential region II, which curve lies outermost in the transition 31 in the radial direction of the vehicle pneumatic tire and has the angle of pitch θᵢ embodied in the transition 31, merges smoothly into a curve of the second family of curves of the circumferential region I. This curve lies outermost in the transition 31 in the radial direction of the vehicle pneumatic tire and has the same angle of pitch θₐ embodied in the transition 31, assigned thereto in a corresponding manner.

FIGS. 5a, 5b, 5c, 5d show an example of circumferential regions of equal size where α=β=γ=δ=ε=ζ=60°, in which the first and second families of curves shown in FIGS. 6a and 6b, designed continuously over the entire circumference of the vehicle pneumatic tire, are realized only in the circumferential regions II in the vehicle pneumatic tire to produce the moiré pattern. The imaginary continuation in the circumferential regions I shown by a broken line are not realized in the vehicle pneumatic tire, but are replaced by the families of curves shown in FIGS. 7a and 7b. As can be seen in FIGS. 5a, 5b, 5c, 5d, all the transitions 31 between the circumferential regions I and II are embodied identically.

To this end, the undulating curves of the first family of curves of the second circumferential region II shown in FIG. 6a are embodied with their frequency such that they extend between the two transitions 31 of a circumferential region II with an integer multiple of the respective wavelength. The undulatory curves of the first family of curves of the second circumferential area II shown in FIG. 6b are embodied such that they both strike transition 31 at the same radial position on the vehicle pneumatic tire and with the same pitch.

It is also conceivable to embody carcass yarns of a material other than polyester yarns. It is particularly expedient to embody a tire sidewall decoration with a moirépattern in the circumferential regions II for tires in which a particularly great danger of discernible constrictions occurs.

### List of Reference Numbers

1 Tread rubber
2 Core
3 Bead reinforcement
4 Core profile
5 Flange profile
6 Inner layer
7 Side strip
8 Carcass ply
9 Carcass ply
10 Shoulder strips
11 Belt ply
12 Belt edge protection
13 Belt ply
14 Belt ply
15 Carcass yarn
16 Carcass yarn
17 Overlap points
18 Overlap points
19 Rubber layer
23 Bead strip
24 Family of curves
25 Family of curves
26 Moiré pattern
27 Family of curves
28 Family of curves
29 Moiré-free pattern
30 Sidewall decoration
31 Transition

1-5. (canceled)

6. A vehicle pneumatic tire comprising:
a carcass having sidewalls and a tread rubber;
a sidewall area covered on an outside by a sidewall rubber strip;
a moiré pattern arranged on the sidewall rubber strip and being formed by a superimposition of at least two linear non-identical families of curves;
a first family of curves of the at least two linear non-identical families of curves being formed by undulatory curves having regular wave form; and
a second family of curves of the at least two linear non-identical families of curves being formed by undulatory curves having irregular wave form.

7. The tire of claim 6, wherein the tire comprises a radial construction.

8. The tire of claim 6, further comprising marking arranged on the sidewall area providing information about the tire.

9. The tire of claim 6, wherein the first family of curves extend in a circumferential direction.

10. The tire of claim 6, wherein the second family of curves extend in a circumferential direction.

11. The tire of claim 6, wherein the second family of curves have an irregular wave form frequency.

12. The tire of claim 6, wherein the second family of curves have a changing wave amplitude.

13. The tire of claim 6, wherein, in a transition between first and second surface areas, a curve of the first family of curves of a first surface area merges smoothly into a curve of a first family of curves of the second surface area.

14. The tire of claim 6, wherein, in a transition between first and second surface areas, a curve of the second family of curves of the first surface area merges smoothly into a curve of the second family of curves of the second surface area.

15. The tire of claim 6, wherein, in a transition between first and second surface areas, curves of the first family of curves of the first surface area merge smoothly into curves of the first family of curves of the first surface area.

16. The tire of claim 6, wherein, in a transition between first and second surface areas, curves of the second family of curves of the first surface area merge smoothly into curves of the second family of curves of the first surface area.

17. The tire of claim 6, wherein, in a transition between first and second surface areas, one curve of the first family of curves of the at least one first surface area merges smoothly into curves of the first family of curves of the second surface area.

18. The tire of claim 6, wherein, in a transition between first and second surface areas, one curve of the second family of curves of the at least one first surface area merges smoothly into curves of the second family of curves of the second surface area.

19. The tire of claim 6, wherein, in a transition between first and second surface areas, a curve of the first family of curves of the first surface area has identical pitch to a curve of the first family of curves of the second surface area.

20. The tire of claim 6, wherein, in a transition between first and second surface areas, a curve of the second family of curves of the first surface area has identical pitch to a curve of the second family of curves of the second surface area.

21. The tire of claim 6, wherein the tire comprises three first surface areas each having markings.

22. The tire of claim 21, wherein the tire comprises a second surface area arranged between two first surface areas.

23. The tire of claim 6, wherein an irregular brightness distribution produced the moiré pattern is superimposed on a variation in a brightness distribution produced by a constriction of one of the sidewalls.

24. The tire of claim 23, wherein the variation in the brightness distribution produced by the constriction is not clearly identifiable as such, whereby only a non-uniform brightness distribution is recognizable

25. A vehicle pneumatic tire comprising:
a sidewall area comprising a sidewall rubber strip;
a moiré pattern arranged on the sidewall area and being formed by a superimposition of first and second linear non-identical families of curves;
the first family of curves being formed by undulating curves having regular wave form; and
the second family of curves being formed by undulating curves having irregular wave form.

26. A vehicle pneumatic tire comprising:
a marking arranged in at least one first surface area of a sidewall;
a moiré pattern arranged on at least one second surface area and being formed by a superimposition of at least two non-identical families of curves;
one family of curves being formed by undulating curves having regular wave form; and
another family of curves being formed by undulating curves having irregular wave form,
wherein an irregular brightness distribution produced the moiré pattern is superimposed on a variation in a brightness distribution produced by a constriction of the sidewall.
